(19) United States
(12) Patent Application Publication
(10) Pub. No.: US 2026/0211261 A1
(43) Pub. Date: Jul. 23, 2026

(54) STEREOSCOPIC SURFACE DISPLAY DEVICE

(71) Applicant: ELECTRONICS AND TELECOMMUNICATIONS RESEARCH INSTITUTE, Daejeon (KR)

(72) Inventors: Suyong KIM, Daejeon (KR); Sung Ryul YUN, Daejeon (KR); Inwook HWANG, Daejeon (KR); Seongcheol MUN, Daejeon (KR); Geonwoo HWANG, Daejeon (KR); Baesun KIM, Daejeon (KR); Mee Jeong CHOI, Daejeon (KR)

(21) Appl. No.: 19/429,468

(22) Filed: Dec. 22, 2025

(30) Foreign Application Priority Data
Jan. 21, 2025 (KR) 10-2025-0008940
Aug. 12, 2025 (KR) 10-2025-0111701

(51) Int. Cl. G02B 30/26; G02B 5/00

(52) U.S. Cl. CPC G02B 30/26; G02B 5/003

(57) ABSTRACT

A stereoscopic surface display device according to some embodiment of the inventive concept includes an optical system including a light source configured to emit light and a light controller configured to control the light emitted from the light source, a fixing unit on the light controller, wherein the light controller emits the light to the fixing unit, a photothermal conversion layer disposed on the fixing unit and configured to absorb the light emitted from the optical system to convert the light into thermal energy, and a property-variable layer on the photothermal conversion layer, wherein the property-variable layer includes a flexible property polymer material, and the fixing unit includes an inlet through which a fluid is introduced.

### CROSS-REFERENCE TO RELATED APPLICATIONS

This U.S. non-provisional patent application claims priority under 35 U.S.C. § 119 of Korean Patent Application Nos. 10-2025-0008940, filed on January 21, 2025, and 10-2025-0111701, filed on August 12, 2025, the entire contents of which are hereby incorporated by reference.

### BACKGROUND

The present disclosure herein relates to a stereoscopic surface display device, and more particularly, to a stereoscopic surface display device including a property-variable layer.

Due to the development and distribution of electronic information apparatuses such as touchscreen-based mobile electronic apparatuses and kiosks, user interfaces and touch interfaces provided on planar visual information displays have become popular. Most planar touch interfaces may provide a haptic feedback in a form of delivering a vibration to a finger when a user touches a surface with the finger.

The haptic feedback uses a motor, a voice coil, or the like as an actuator to control a dynamic driving signal and provide a feeling of clicking a button. However, the haptic feedback technology using the motor, the voice coil, or the like in this way requires large power consumption and difficult miniaturization. In order to address such issues, various studies have been performed.

In addition, surfaces of such haptic feedback devices may be connected to several actuators and the actuators may make only local deformations, thereby providing users with limited sense of touch. Accordingly, it is required to provide haptic feedback devices for providing sense of touch through global modifications.

### SUMMARY

The present disclosure provides a stereoscopic surface display device with high power efficiency and durability.

The present disclosure also provides a globally and locally deformable stereoscopic surface display device.

An embodiment of the inventive concept provides a stereoscopic surface display device including: an optical system including a light source configured to emit light and a light controller configured to control the light emitted from the light source; a fixing unit on the light controller, wherein the light controller may emit the light to the fixing unit; a photothermal conversion layer disposed on the fixing unit and configured to absorb the light emitted from the optical system to convert the light into thermal energy; and a property-variable layer on the photothermal conversion layer, wherein the property-variable layer may include a flexible property polymer material, and the fixing unit may include an inlet through which a fluid is introduced.

In an embodiment of the inventive concept, a stereoscopic surface display device includes: an optical system including a light source configured to emit light and a light controller configured to control the light emitted from the light source; a fixing unit on the light controller, wherein the light controller may emit the light to the fixing unit; a photothermal conversion layer disposed on the fixing unit and configured to absorb the light emitted from the light controller to convert the light into thermal energy; and a property-variable layer on the photothermal conversion layer, wherein the property-variable layer may include a flexible property polymer material, the fixing unit may include a lower portion on the light controller, and the lower portion of the fixing unit may be transparent.

In an embodiment of the inventive concept, a stereoscopic surface display device includes: an optical system including a light source configured to emit light and a light controller configured to control the light emitted from the light source; a fixing unit on the light controller, wherein the light controller may emit the light to the fixing unit; a photothermal conversion layer disposed on the fixing unit and configured to absorb the light emitted from the optical system to convert the light into thermal energy; and a property-variable layer on the photothermal conversion layer, wherein the property-variable layer may include a flexible property polymer material, the photothermal conversion layer and the optical system may be spaced apart from each other, the fixing unit may be disposed between the photothermal conversion layer and the optical system, and the fixing unit may transmit the light emitted from the optical system to the photothermal conversion layer.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a drawing indicating a stereoscopic surface display device according to some embodiments;

FIGS. 2A, 2B and 2C are drawings indicating an operation method of a stereoscopic surface display device according to some embodiments;

FIGS. 3A and 3B are drawings indicating an operation method of a stereoscopic surface display device according to some embodiments;

FIG. 4 is a drawing indicating an operation method of a stereoscopic surface display device according to some embodiments;

FIGS. 5A, 5B, 5C and 5D are drawings indicating stereoscopic shapes using a stereoscopic surface display device according to some embodiments; and

FIG. 6 is a drawing indicating a stereoscopic surface display device according to some embodiments.

FIG. 7 is a drawing indicating a stereoscopic surface display device according to some embodiments.

### DETAILED DESCRIPTION

Hereinafter, an optical device according to embodiments of the inventive concept will be described with reference to the drawings.

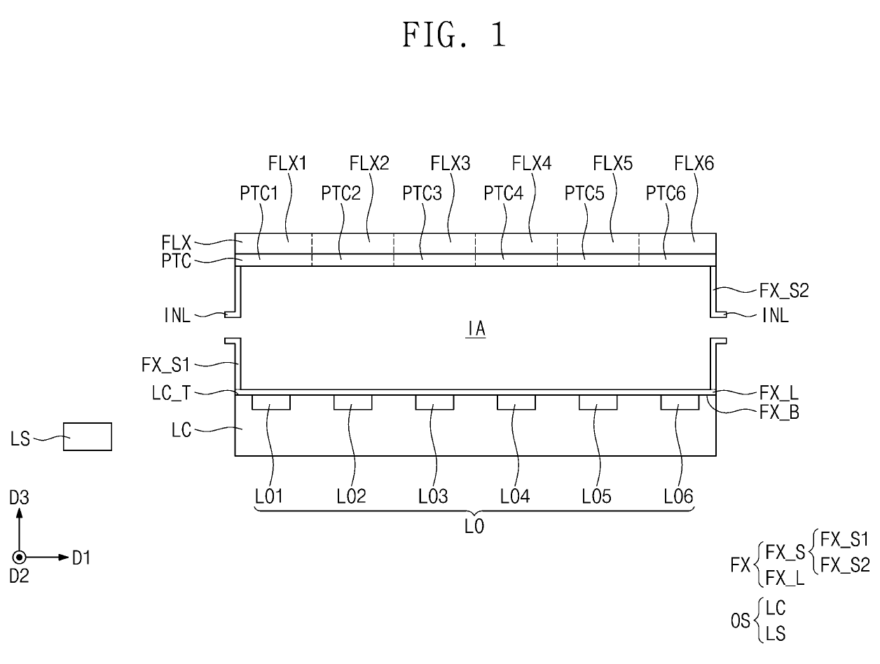

FIG. 1 is a drawing indicating a stereoscopic surface display device according to some embodiments.

Referring to FIG. 1, the stereoscopic surface display device may include an optical system OS. The optical system OS may include a light controller LC and a light source LS. The light source LS may emit light. The light source LS may include, for example, an LED, a laser diode LD, or a lamp.

The light controller LC may include optical elements configured to control the light. The light controller LC may include, for example, a digital micromirror device (DMD), a galvanometer, a liquid crystal display (LCD), a spatial light modulator (SLM), an acousto-optic deflector (AOD), or a micro electro-mechanical system (MEMS) mirror.

The light controller LC may include a top surface LC_T. The light controller LC may include a light output unit LO connected to the top surface LC_T of the light controller LC. The top surface LC_T of the light controller LC may include a top surface of the light output unit LO. The top surface LC_T of the light controller LC may have a planar shape parallel to a first direction D1 and a second direction D2. The first direction D1 and the second direction D2 may cross each other. For example, the first direction D1 and the second direction D2 may be horizontal directions perpendicular to each other. The light output unit LO may include a first light output unit LO1, a second light output unit LO2, a third light output unit LO3, a fourth light output unit LO4, a fifth light output unit LO5, and a sixth light output unit LO6 arranged in the first direction D1.

A fixing unit FX may be provided on the top surface LC_T of the light controller LC. In some embodiments, the fixing unit FX may directly contact the top surface LC_T of the light controller LC. In some embodiments, the fixing unit FX may be spaced apart from the top surface LC_T of the light controller LC in a third direction D3. The third direction D3 may cross the first direction D1 and the second direction D2. For example, the third direction D3 may be a vertical direction perpendicular to the first direction D1 and the second direction D2. When the fixing unit FX is spaced apart from the top surface LC_T of the light controller LC, a support unit configured to fix the fixing unit FX on the light controller LC may be further provided. The support unit may be, for example, a pad contacting the fixing unit FX and the light controller LC.

The fixing unit FX may include an inlet INL. The inlet INL may be connected to a sidewall unit FX_S of the fixing unit FX. The inlet INL may define a hole connected to an inner space IA of the fixing unit FX. In some embodiments, the fixing unit FX may include a hydraulic chamber or a pneumatic chamber into which air or fluid is introduced through the inlet INL.

The fixing unit FX may include a lower portion FX_L. The lower portion FX_L of the fixing unit FX may have a shape of a plate that extends along a plane extending along the first direction D1 and the second direction D2. The sidewall unit FX_S of the fixing unit FX may be connected to the lower portion FX_L of the fixing unit FX. The lower portion FX_L of the fixing unit FX may include a bottom surface FX_B of the fixing unit FX. The lower portion FX_L of the fixing unit FX may be transparent. The bottom surface FX_B of the fixing unit FX may be transparent. The bottom surface FX_B of the fixing unit FX may be disposed on the top surface LC_T of the light controller LC.

The sidewall unit FX_S of the fixing unit FX may include a first sidewall unit FX_S1 and a second sidewall unit FX_S2 spaced apart from each other in the first direction D1. The first sidewall unit FX_S1 and second sidewall unit FX_S2 of the fixing unit FX may be connected to each other by the lower portion FX_L. The inlet INL of the fixing unit FX may include a first inlet connected to the first sidewall unit FX_S1 and a second inlet connected to the second sidewall unit FX_S2. In some embodiments, the fixing unit FX may not include the second inlet connected to the second sidewall unit FX_S2.

A photothermal conversion layer PTC may be provided on the fixing unit FX. The photothermal conversion layer PTC may include a first portion PTC1, a second portion PTC2, a third portion PTC3, a fourth portion PTC4, a fifth portion PTC5, and a sixth portion PTC6 arranged in the first direction D1. The first to sixth portions PTC1, PTC2, PTC3, PTC4, PTC5, and PTC6 of the photothermal conversion layer PTC may respectively overlap the first to sixth light output units LO1, LO2, LO3, LO4, LO5, and LO6 in the third direction D3.

The photothermal conversion layer PTC may include a photothermal conversion material absorbing light in a specific wavelength band to convert the light into thermal energy. The photothermal conversion layer PTC may include a carbon-based photothermal conversion material, for example, graphene nanoplatelet-polydimethylsiloxane composite elastomer or equivalent. The photothermal conversion layer PTC may include a composite material including various photothermal conversion materials.

The photothermal conversion layer PTC, the sidewall unit FX_S of the fixing unit FX, and the lower portion FX_L of the fixing unit FX may define the inner space IA of the fixing unit FX. The photothermal conversion layer PTC may contact the sidewall unit FX_S of the fixing unit FX. The photothermal conversion layer PTC may be spaced apart from the lower portion FX_L of the fixing unit FX in the third direction D3.

A property-variable layer FLX may be provided on the photothermal conversion layer PTC. The property-variable layer FLX may contact the photothermal conversion layer PTC. The property-variable layer FLX may include a first portion FLX1, a second portion FLX2, a third portion FLX3, a fourth portion FLX4, a fifth portion FLX5, and a sixth portion FLX6 arranged in the first direction D1. The first to sixth portions FLX1, FLX2, FLX3, FLX4, FLX5, and FLX6 of the property-variable layer FLX may respectively overlap the first to sixth portions PTC1, PTC2, PTC3, PTC4, PTC5, and PTC6 of the photothermal conversion layer PTC in the third direction D3. The first to sixth portions FLX1, FLX2, FLX3, FLX4, FLX5, and FLX6 of the property-variable layer FLX may respectively overlap the first to sixth light output units LO1, LO2, LO3, LO4, LO5, and LO6 in the third direction D3.

The inner space IA of the fixing unit FX may be formed as one space, and the first to sixth portions PTC1, PTC2, PTC3, PTC4, PTC5, and PTC6 of the photothermal conversion layer PTC may all be connected to the one inner space IA of the fixing unit FX.

The property-variable layer FLX may include a flexible polymer material. The property-variable layer FLX may include a flexible property polymer material of which properties change according to temperature. The property-variable layer FLX may include, for example, poly(tert-butyl acrylate) (PtBA) or a polymer with similar property change.

A stereoscopic surface display device according to some embodiments has a transparent lower portion FX_L of the fixing unit FX and enables light emitted from the light output unit LO to pass through the lower portion FX_L of the fixing unit FX to be delivered to the photothermal conversion layer PTC.

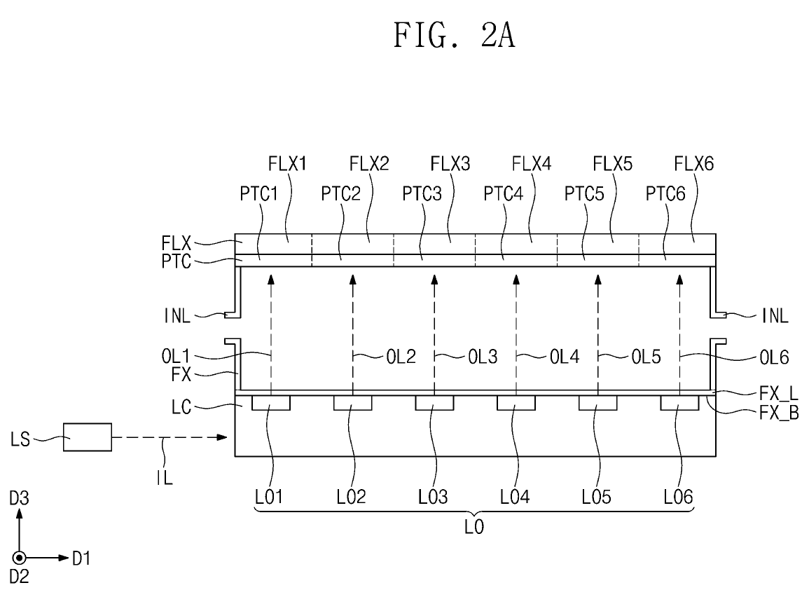

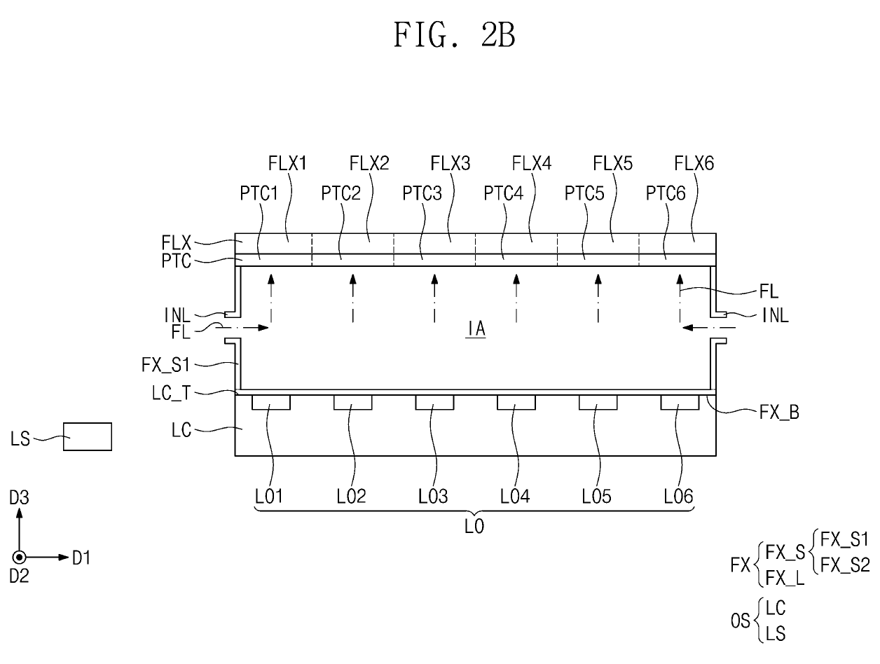

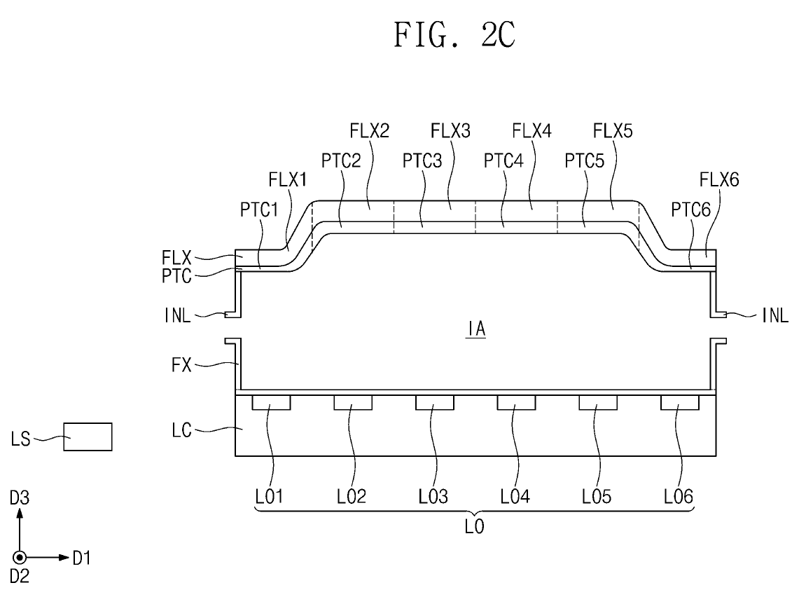

FIGS. 2A, 2B and 2C are drawings indicating an operation method of a stereoscopic surface display device according to some embodiments.

Referring to FIGS. 2A, the light source LS may emit incident light IL. The incident light IL may be light emitted from the light source LS. The incident light IL may travel to the light controller LC. The light controller LC may control the received incident light IL to emit first output light OL1, second output light OL2, third output light OL3, fourth output light OL4, fifth output light output OL5, and sixth output light OL6. The first to sixth output lights OL1, OL2, OL3, OL4, OL5, and OL6 may be emitted from the light controller LC. The first to sixth output lights OL1, OL2, OL3, OL4, OL5, and OL6 may pass through the lower portion FX_L of the fixing unit FX.

The first to sixth output lights OL1, OL2, OL3, OL4, OL5, and OL6 passing through the lower portion FX_L of the fixing unit FX may be absorbed by the photothermal conversion layer PTC. The first to sixth output lights OL1, OL2, OL3, OL4, OL5, and OL6 may be respectively absorbed by first to sixth portions PTC1, PTC2, PTC3, PTC4, PTC5, and PTC6 of the photothermal conversion layer PTC. The photothermal conversion layer PTC may absorb the first to sixth output lights OL1, OL2, OL3, OL4, OL5, and OL6 to have an increase in temperature.

The first to sixth output lights OL1, OL2, OL3, OL4, OL5, and OL6 may be respectively emitted from the first to sixth light output units LO1, LO2, LO3, LO4, LO5, and LO6 of the light controller LC. Intensities and wavelength bands of the first to sixth output lights OL1, OL2, OL3, OL4, OL5, and OL6 may be different from each other. For example, the intensities of the first output light OL1 and the sixth output light OL6 may be smaller than those of the second to fifth output lights OL2, OL3, OL4, and OL5. Accordingly, temperature increase amounts of the first portion PTC1 and sixth portion PTC6 of the photothermal conversion layer PTC may be smaller than those of the second to fifth output lights PTC2, PTC3, PTC4, and PTC5.

Due to the increase in temperature of the photothermal conversion layer PTC, a temperature of the property-variable layer FLX may increase. Heat may be moved from the photothermal conversion layer PTC to the property-variable layer FLX due to thermal conduction. Due to an increase in temperature of the property-variable layer FLX, the properties of the property-variable layer FLX may change. For example, stiffness of the property-variable layer FLX may be lowered.

Referring to FIG. 2B, a fluid FL may be introduced through the inlet INL. The fluid FL may include, for example, air. A pressure of the inner space IA of the fixing unit FX may increase due to the fluid FL. As the pressure of the inner space IA of the fixing unit FX increases, a pressure may be applied to the photothermal conversion layer PTC and the property-variable layer FLX in the third direction D3.

Referring to FIG. 2C, the shapes of the photothermal conversion layer PTC and the property-variable layer FLX may be globally deformed. The deformed photothermal conversion layer PTC and the property-variable layer FLX may be convex upward. The property-variable layer FLX may be heated to decrease the stiffness and be curved convex upward due to the pressure applied by the fluid FL. In some embodiments, heating the property-variable layer FLX and increasing the pressure of the inner space IA of the fixing unit FX may be performed substantially simultaneously. The second to fifth portions FLX2, FLX3, FLX4, and FLX5 of the property-variable layer FLX may be arranged at a higher level than those of the first portion FLX1 and the sixth portion FLX6. While the shapes of the property-variable layer FLX and the photothermal conversion layer PTC change, thicknesses in the third direction D3 may also change.

Although only the upward convex shapes of the photothermal conversion layer PTC and the property-variable layer FLX are shown, the property-variable layer FLX and the photothermal conversion layer PTC may be concave downward. In this case, the fluid is discharged through the inlet INL and the pressure of the inner space IA of the fixing unit FX is lowered, and thus the shapes of the photothermal conversion layer PTC and the property-variable layer FLX may turn concave downward.

In an operation method of a stereoscopic surface display according to some embodiments, fluid may be introduced or discharged through the inlet INL to change the pressure of the inner space IA of the fixing unit FX, thereby facilitating a change in the shapes of the photothermal conversion layer PTC and the property-variable layer FLX.

In an operation method of a stereoscopic surface display according to some embodiments, the first to sixth portions PTC1, PTC2, PTC3, PTC4, PTC5, and PTC6 of the photothermal conversion layer PTC may be connected to the one inner space IA of the fixing unit FX. Accordingly, the shapes of the first to sixth portions PTC1, PTC2, PTC3, PTC4, PTC5, and PTC6 of the photothermal conversion layer PTC and the first to sixth portions FLX1, FLX2, FLX3, FLX4, FLX5, and FLX6 of the property-variable layer FLX may globally change. Accordingly, not only a partial region of the stereoscopic surface display is locally deformed, but the global shape may be also deformed.

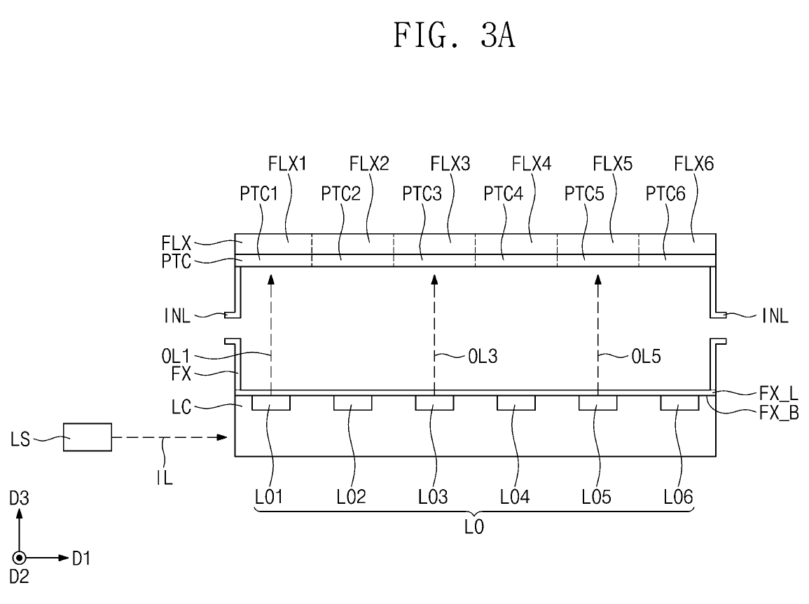

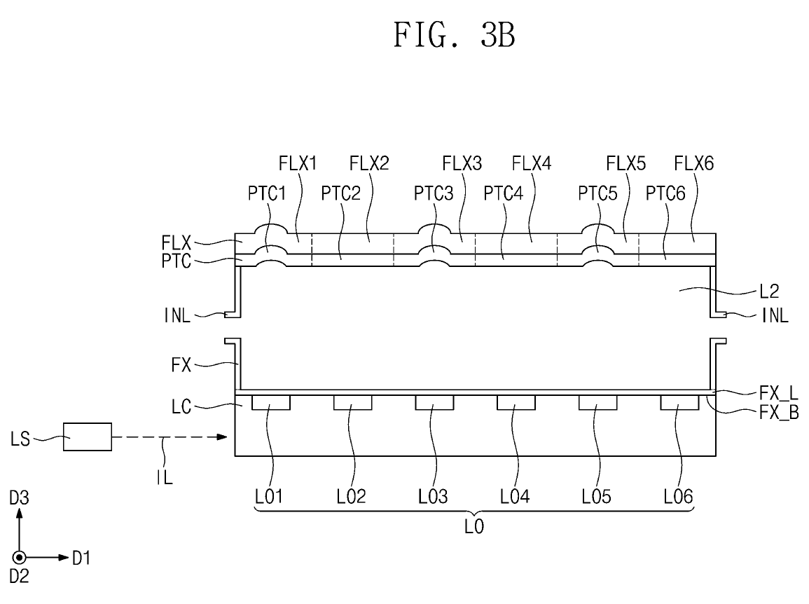

FIGS. 3A and 3B are drawings indicating an operation method of a stereoscopic surface display device according to some embodiments. Except the following description, the operation method of a stereoscopic surface display device according to FIGS. 3A and 3B may be similar to that of the stereoscopic surface display device according to FIGS. 2A, 2B and 2C.

Referring to FIG. 3A, the first output light OL1, the third output light OL3, and the fifth output light OL5 may be respectively output from the first light output unit LO1, the third light output unit LO3, and the fifth light output unit LO5. Unlike FIGS. 2A,2B and 2C, the second light output unit LO2, the fourth light output unit LO4, and the sixth light output unit LO6 may not emit light. The first output light OL1, the third output light OL3, and the fifth output light OL5 may be selectively output by operations of optical elements of the light controller LC. The first output light OL1, the third output light OL3, and the fifth output light OL5 may be respectively absorbed by the first portion PTC1, the third PTC3, and the fifth portion PTC5 of the photothermal conversion layer PTC.

Temperatures of the first portion PTC1, the third PTC3, and the fifth portion PTC5 of the photothermal conversion layer PTC may increase. Accordingly, temperatures of the first portion FLX1, the third portion FLX3, and the fifth portion FLX5 of the property-variable layer FLX respectively contacting the first portion PTC1, the third PTC3, and the fifth portion PTC5 of the photothermal conversion layer PTC may increase.

Referring to FIG. 3B, the shapes of the first portion PTC1, the third PTC3, and the fifth portion PTC5 of the photothermal conversion layer PTC and the first portion FLX1, the third portion FLX3, and the fifth portion FLX5 of the property-variable layer FLX may locally change.

Center portions of the first portion PTC1, the third PTC3, and the fifth portion PTC5 of the deformed photothermal conversion layer PTC and the first portion FLX1, the third portion FLX3, and the fifth portion FLX5 of the deformed property-variable layer FLX may be convex upward.

Although not illustrated, the shapes of the first portion PTC1, the third PTC3, and the fifth portion PTC5 of the photothermal conversion layer PTC and the first portion FLX1, the third portion FLX3, and the fifth portion FLX5 of the property-variable layer FLX may change due to a pressure of the fluid.

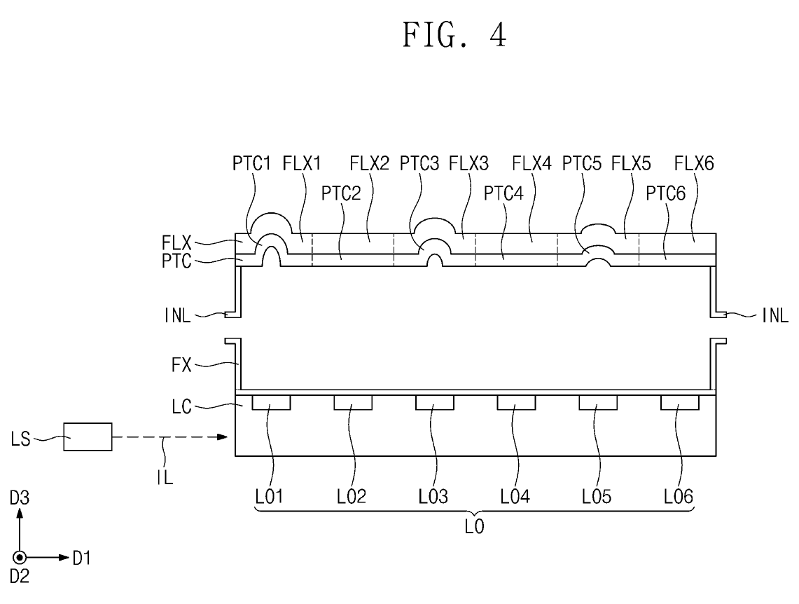

FIG. 4 is a drawing indicating an operation method of a stereoscopic surface display device according to some embodiments. Except the following description, the operation method of a stereoscopic surface display device according to FIG. 4 may be similar to those of the stereoscopic surface display devices according to FIGS. 3A and 3B.

Referring to FIG. 4, the first portion PTC1, the third PTC3, and the fifth portion PTC5 of the photothermal conversion layer PTC and the first portion FLX1, the third portion FLX3, and the fifth portion FLX5 of the property-variable layer FLX may be deformed. A level of a highest portion of the deformed first portion PTC1 of the photothermal conversion layer PTC may be higher than that of a highest portion of the deformed third portion PTC3 of the photothermal conversion layer PTC. The level of the highest portion of the deformed third portion PTC3 of the photothermal conversion layer PTC may be higher than that of a highest portion of the fifth portion PTC5 of the photothermal conversion layer PTC.

A level of a highest portion of the deformed first portion FLX1 of the property-variable layer FLX may be higher than that of a highest portion of the deformed third portion FLX3 of the property-variable layer FLX. The level of the highest portion of the deformed third portion FLX3 of the property-variable layer FLX may be higher than that of a highest portion of the deformed fifth portion FLX5 of the property-variable layer FLX.

Intensity of the first output light OL1 emitted from the first light output unit LO1 may be greater than that of the third output light OL3 emitted from the third light output unit LO3. The intensity of the third output light OL3 emitted from the third light output unit LO3 may be greater than that of the fifth output light OL5 emitted from the fifth light output unit LO5. Accordingly, a temperature change amount of the first portion PTC1 of the photothermal conversion layer PTC may be greater than that of the third portion PTC3, and the temperature change amount of the third portion PTC3 of the photothermal conversion layer PTC may be greater than that of the fifth portion PTC5. Accordingly, a change amount of stiffness of the first portion FLX1 of the property-variable layer FLX may be greater than that of the third portion FLX3, and the change amount of the stiffness of the third portion FLX3 of the property-variable layer FLX may be greater than that of the fifth portion FLX5. Accordingly, shape change amounts of the first, third, and fifth portions FLX1, FLX3, and FLX5 of the property-variable layer FLX may be different.

In a stereoscopic surface display device according to some embodiments, the light controller LC may adjust the intensities of the output lights OL1, OL2, OL3, OL4, OL5, and OL6, or selectively output the lights OL1, OL2, OL3, OL4, OL5, and OL6. Accordingly, shape changes of the photothermal conversion layer PTC and the property-variable layer FLX may be locally adjusted.

A stereoscopic surface display device according to some embodiments may combine an output intensity of the light source LS and an output intensity of the light controller LC to finely adjust the intensities of the output lights OL1, OL2, OL3, OL4, OL5, and OL6. Accordingly, the shape changes of the photothermal conversion layer PTC and the property-variable layer FLX may be finely adjusted. Accordingly, when a user interacts with a stereoscopic surface display device, a fine sense of touch may be provided.

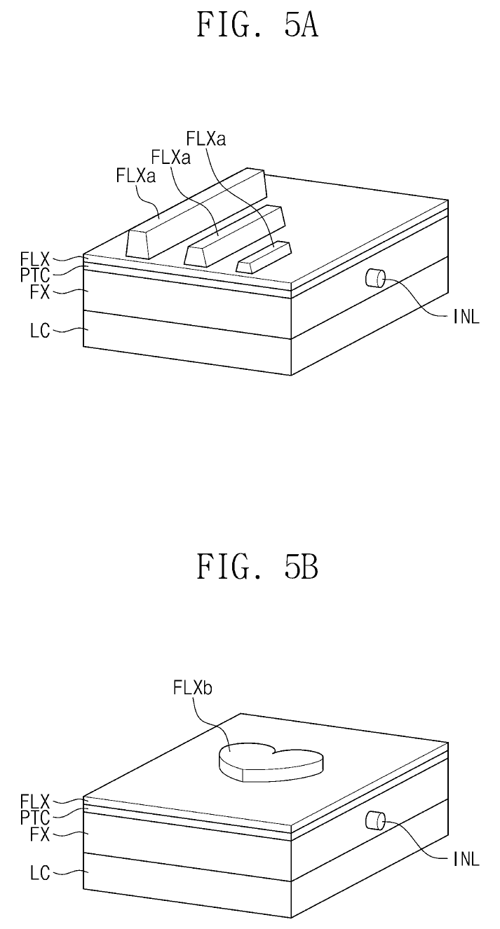

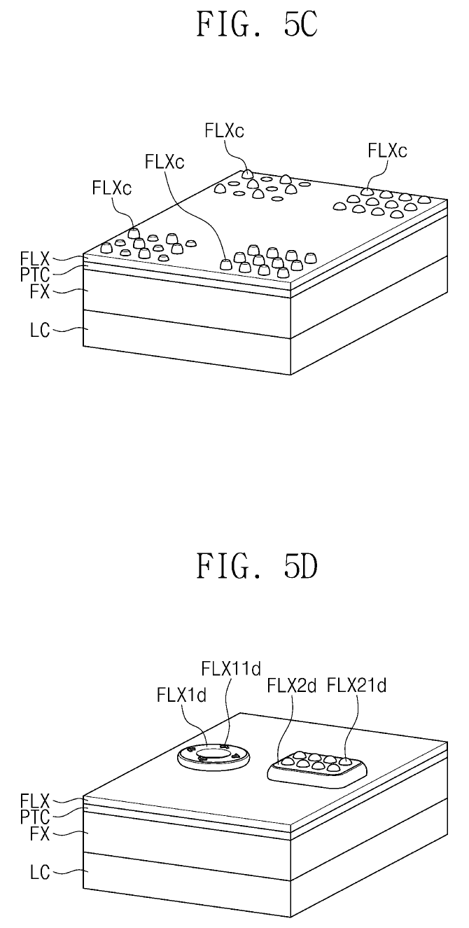

FIGS. 5A, 5B, 5C and 5D are drawings indicating stereoscopic shapes using a stereoscopic surface display device according to some embodiments. The stereoscopic shapes according to FIGS. 5A.5B,5C and 5D may be formed using the global deformation of FIGS. 2A, 2B and 2C and the local deformation of FIGS. 3A and 3B.

Referring to FIG. 5A, a shape of a portion FLXa of the property-variable layer FLX may include a shape of a graph FLXa.

Referring to FIG. 5B, a shape of a portion FLXb of the property-variable layer FLX may include a figure. The diagram is shown as a heart shape, but the embodiment of the inventive concept is not limited thereto.

A stereoscopic surface display device according to some embodiments may identify a graph shape and a figure shape by sense of touch using the stereoscopic surface display device to be used as educational materials or the like for the visually impaired.

Referring to FIG. 5C, shapes of portions FLXc of the property-variable layer FLX may change. The shapes of the portions FLXc of the property-variable layer FLX may change in various ways. Accordingly, a user may feel various senses of touch, for example, lubricity, coarseness, or softness. Accordingly, a realistic touch feedback may be provided in an environment such as virtual reality (VR) or augmented reality (AR). In addition, such a touch feedback may be used in an electronic commerce field to identify a product’s material by touch without being face-to-face.

Referring to FIG. 5D, shapes of a first portion FLX1d and a second portion FLX2d of the property-variable layer FLX may change. The first portion FLX1d of the property-variable layer FLX may be a button shape. The first portion FLX1d of the property-variable layer FLX may include an arrow pattern FLX11d. The second portion FLX2d of the property-variable layer FLX may be a button shape. The second portion FLX2 of the property-variable layer FLX may include a bump pattern FLX21d.

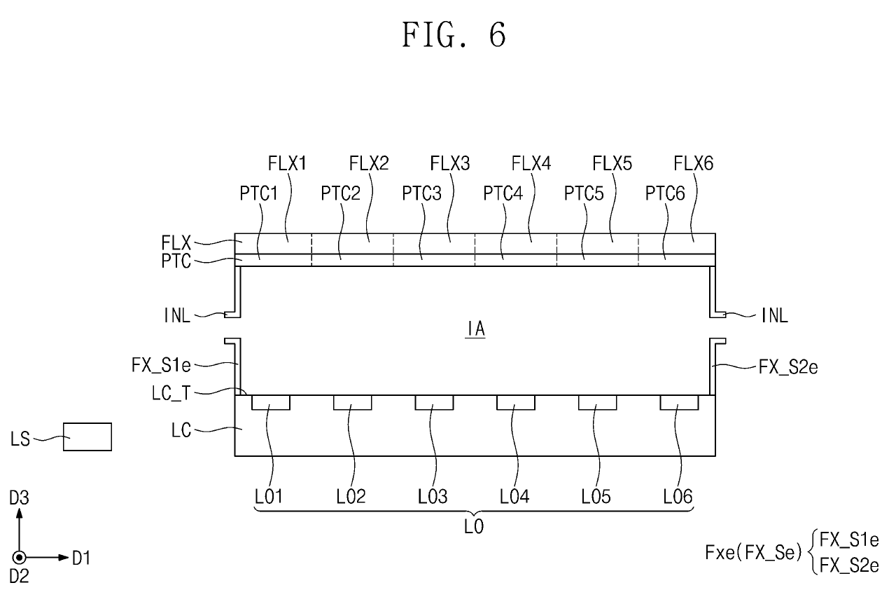

FIG. 6 is a drawing indicating a stereoscopic surface display device according to some embodiments. Referring to FIG. 6, a fixing unit FXe may include a sidewall unit FX_Se. The sidewall unit FX_Se of the fixing unit FXe may include a first sidewall unit FX_S1e and a second sidewall unit FX_S2e. Unlike the stereoscopic surface display device of FIG. 1, the fixing unit FXe may not include the lower portion FX_L (of FIG. 1). The sidewall unit FX_Se of the fixing unit FXe may be disposed on the light controller LC. The sidewall unit FX_Se of the fixing unit FXe may be directly connected to the top surface LC_T of the light controller LC. The top surface LC_T of the light controller LC, the sidewall unit FX_Se of the fixing unit FXe, and the photothermal conversion layer PTC may define the inner space IA of the fixing unit FXe.

In a stereoscopic surface display device according to some embodiments, the fixing unit FXe does not include a lower portion, and the sidewall unit FX_Se of the fixing unit FXe may be directly connected to the top surface LC_T of the light controller LC. Accordingly, the light emitted from the light controller LC may pass through the inner space IA of the fixing unit FXe to be directly delivered to the photothermal conversion layer PTC.

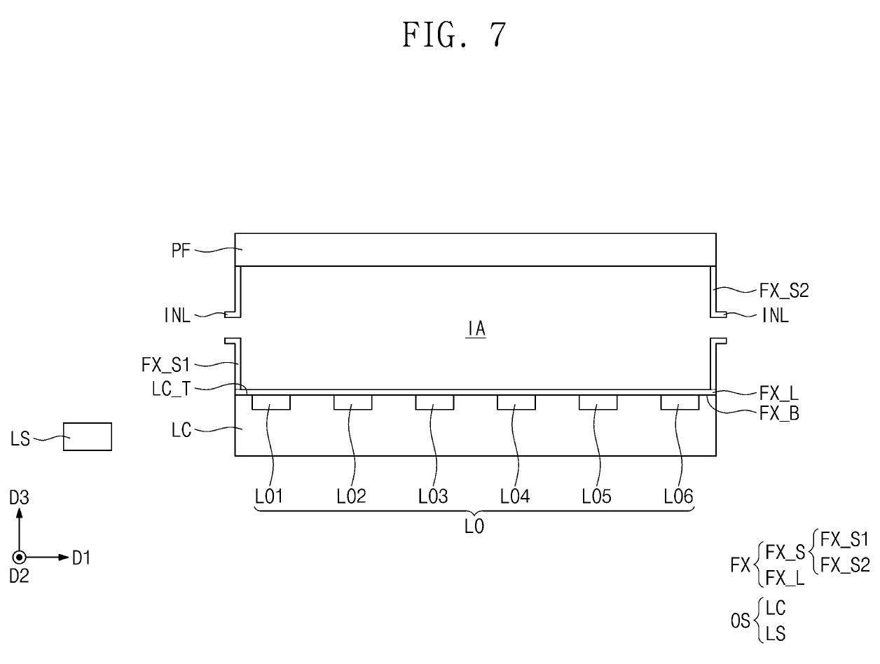

FIG. 7 is a drawing indicating a stereoscopic surface display device according to some embodiments. Except the following description, the stereoscopic surface display device according to FIG. 7 may be similar to the stereoscopic surface display device according to FIG. 1.

Referring to FIG. 7, the stereoscopic surface display device may include a deformation layer PF disposed on the fixing unit FX. The deformation layer PF may include a photothermal conversion material or a flexible property polymer material. In some embodiments, the deformation layer PF may include a mixture of the photothermal conversion material and the flexible property polymer material. In some embodiments, the deformation layer PF may include a material capable of absorbing light to convert the light into thermal energy and absorbing the thermal energy to have a change in property. The deformation layer PF may have a shape in which the photothermal conversion layer PTC and the property-variable layer FLX of FIG. 1 are combined to be one layer.

A stereoscopic surface display device according to embodiments of the inventive concept may have a fixing unit of which a lower portion is transparent, and thus light emitted from a light output unit may pass the lower portion of the fixing unit to be delivered to a photothermal conversion layer.

In an operation method of a stereoscopic surface display according to embodiments of the inventive concept, fluid is introduced or discharged through an inlet to change a pressure of an inner space of a fixing unit, thereby facilitating a change in shapes of a photothermal conversion unit and a property-variable layer.

In an operation method of a stereoscopic surface display according to embodiments of the inventive concept, an entire photothermal conversion layer may be connected to one inner space of a fixing unit. Accordingly, a shape of a property-variable layer may be globally changed. Therefore, not only a partial region may be locally deformed, but the stereoscopic surface display may also be globally deformed.

The embodiments of the inventive concept have been described above with reference to the accompanying drawings, but those skilled in the art will understand that the inventive concept may be carried out in another concrete form without changing the technical spirit or an essential feature thereof. It is therefore to be understood that the above-described embodiments are illustrative in all aspects and not restrictive.

What is claimed is:

1. A stereoscopic surface display device comprising:
an optical system comprising a light source configured to emit light and a light controller configured to control the light emitted from the light source;
a fixing unit on the light controller, wherein the light controller emits the light to the fixing unit;
a photothermal conversion layer disposed on the fixing unit and configured to absorb the light emitted from the optical system to convert the light into thermal energy; and
a property-variable layer on the photothermal conversion layer,
wherein the property-variable layer comprises a flexible property polymer material, and the fixing unit comprises an inlet through which a fluid is introduced.

2. The stereoscopic surface display device of claim 1,
wherein the fixing unit comprises a lower portion on the light controller,
the lower portion of the fixing unit is transparent, and
the light emitted from the light controller passes through the lower portion of the fixing unit.

3. The stereoscopic surface display device of claim 1,
wherein the property-variable layer comprises poly(tert-butyl acrylate) (PtBA).

4. The stereoscopic surface display device of claim 1,
wherein the fixing unit comprises a first sidewall unit and a second sidewall unit spaced apart from each other, and
the inlet comprises a first inlet connected to the first sidewall unit of the fixing unit and a second inlet connected to the second sidewall unit of the fixing unit.

5. The stereoscopic surface display device of claim 1,
wherein the light controller includes a digital micromirror device (DMD), a galvanometer, a liquid crystal display (LCD), a spatial light modulator (SLM), an acousto-optic deflector (AOD), or a micro electro-mechanical system (MEMS) mirror.

6. The stereoscopic surface display device of claim 1,
wherein the photothermal conversion layer comprises graphene nanoplatelet-polydimethylsiloxane composite elastomer (GNPE).

7. The stereoscopic surface display device of claim 1,
wherein the fixing unit comprises a lower portion and a sidewall unit,
the lower portion of the fixing unit is spaced apart from the photothermal conversion layer, and
the sidewall unit of the fixing unit is connected to the photothermal conversion layer.

8. The stereoscopic surface display device of claim 7,
wherein the inlet is connected to the sidewall unit of the fixing unit.

9. The stereoscopic surface display device of claim 1,
wherein the fixing unit comprises a sidewall unit,
wherein the sidewall unit of the fixing unit is connected to the optical system and the photothermal conversion layer.

10. A stereoscopic surface display device comprising:
an optical system comprising a light source configured to emit light and a light controller configured to control the light emitted from the light source;
a fixing unit on the light controller, wherein the light controller emits the light to the fixing unit;
a photothermal conversion layer disposed on the fixing unit and configured to absorb the light emitted from the light controller to convert the light into thermal energy; and
a property-variable layer on the photothermal conversion layer,
wherein the property-variable layer comprises a flexible property polymer material,
the fixing unit comprises a lower portion on the light controller, and
the lower portion of the fixing unit is transparent.

11. The stereoscopic surface display device of claim 10,
wherein the property-variable layer comprises poly(tert-butyl acrylate) (PtBA).

12. The stereoscopic surface display device of claim 10,
wherein the fixing unit comprises a sidewall unit,
wherein the sidewall unit of the fixing unit connects the lower portion of the fixing unit and the photothermal conversion layer.

13. The stereoscopic surface display device of claim 10,
wherein the photothermal conversion layer comprises graphene nanoplatelet-polydimethylsiloxane composite elastomer (GNPE).

14. A stereoscopic surface display device comprising:
an optical system comprising a light source configured to emit light and a light controller configured to control the light emitted from the light source;
a fixing unit on the light controller, wherein the light controller emits the light to the fixing unit;
a photothermal conversion layer disposed on the fixing unit and configured to absorb the light emitted from the optical system to convert the light into thermal energy; and
a property-variable layer on the photothermal conversion layer,
wherein the property-variable layer comprises a flexible property polymer material,
the photothermal conversion layer and the optical system are spaced apart from each other,
the fixing unit is disposed between the photothermal conversion layer and the optical system, and
the fixing unit transmits the light emitted from the optical system to the photothermal conversion layer.

15. The stereoscopic surface display device of claim 14,
wherein the property-variable layer contacts a top surface of the photothermal conversion layer.

16. The stereoscopic surface display device of claim 14,
wherein the fixing unit comprises an inlet through which a fluid is introduced,
wherein the fluid is a gas.

17. The stereoscopic surface display device of claim 14,
wherein the fixing unit comprises a hydraulic chamber or a pneumatic chamber.

18. The stereoscopic surface display device of claim 14,
wherein the photothermal conversion layer comprises graphene nanoplatelet-polydimethylsiloxane composite elastomer (GNPE).

19. The stereoscopic surface display device of claim 14,
wherein a sidewall unit of the fixing unit is connected to a top surface of the light controller.

20. The stereoscopic surface display device of claim 19,
wherein the sidewall unit of the fixing unit, the top surface of the light controller, and the photothermal conversion layer define an inner space of the fixing unit.
